(19) United States
(12) Patent Application Publication
(10) Pub. No.: US 2008/0062571 A1
(43) Pub. Date: Mar. 13, 2008

(54) Head suspension assembly and flexure and head gimbal assembly

(75) Inventors: Kouichi Toukairin, Kawasaki (JP); Hirofumi Suzuki, Kawasaki (JP); Hideki Yamaguchi, Kawasaki (JP); Hiroaki Kobayashi, Kawasaki (JP); Hiroshi Minami, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/704,032

(22) Filed: Feb. 8, 2007

(30) Foreign Application Priority Data
Sep. 11, 2006 (JP) 2006-245414

(51) Int. Cl. G11B 5/105

(52) U.S. Cl. 360/245.9

(57) ABSTRACT

A head suspension assembly has a flexure partly fixed to a head suspension. The flexure is made of a single plate material. The flexure defines at least a thin portion and a thick portion. The thin portion is received on the head suspension for supporting a head slider. The thin portion has a first thickness. The thick portion is formed at a position outside the contour of the head suspension. The thick portion has a second thickness larger than the first thickness. The thick portion exhibits a sufficient rigidity. The thick portion can thus be aligned with a receiving member in a facilitated manner. Moreover, the thin portion of the flexure has the first thickness smaller than the second thickness. The thin portion has a reduced rigidity. A reduced rigidity allows the thin portion or head slider to enjoy a responsive change in the attitude.

### BACKGROUND OF THE INVENTION

1. Field of the Invention

The present invention relates to a head suspension assembly employed in a storage medium drive such as hard disk drive, HDD.

2. Description of the Prior Art

A carriage is incorporated in a hard disk drive, for example. The carriage includes a head suspension attached to the front or tip end of the carriage arm. A flexure is partly fixed to the head suspension. The flexure supports a head slider at the front end of the flexure. The flexure is designed to extend backward from the head suspension. The flexure has the structure of a so-called long-tail. The rear end of the flexure is supported on a flexible printed wiring board on the carriage at a position near the rotation axis of the carriage. A wiring pattern formed on the flexure serves to establish electrical connection between the head slider and the flexible printed wiring board.

The wiring pattern on the flexure is connected to the flexible printed wiring board. The flexure is required to have a sufficient rigidity when the wiring pattern is to be positioned relative to the flexible printed wiring board. The flexure is made out of a stainless steel plate, for example. Since the head slider is supported on the flexure, the flexure is made thin for realization of change in the attitude of the head slider. The flexure cannot have a sufficient rigidity. The wiring pattern on the flexure cannot thus be positioned on the flexible printed wiring board in a facilitated manner during the assembling of the carriage.

### SUMMARY OF THE INVENTION

It is accordingly an object of the present invention to provide a head suspension assembly and a head gimbal assembly capable of connecting a wiring pattern without any difficulty.

According to a first aspect of the present invention, there is provided a head suspension assembly comprising: a head suspension; a flexure partly fixed to the head suspension and extending outward from the contour of the head suspension, the flexure made of a single plate material; and a wiring pattern formed on the flexure. The flexure defines at least a thin portion and a thick portion. The thin portion is received on the head suspension for supporting a head slider. The thin portion has a first thickness. The thick portion is formed at a position outside the contour of the head suspension. The thick portion has a second thickness larger than the first thickness.

The head suspension assembly allows the thick portion of the flexure to have the second thickness larger than the first thickness. The thick portion is located at a position outside the contour of the head suspension. The thick portion exhibits a sufficient rigidity. The thick portion can thus be aligned with a member receiving the wiring pattern in a facilitated manner. The wiring pattern can be connected without any difficulty. Moreover, the thin portion of the flexure has the first thickness smaller than the second thickness. The thin portion has a reduced rigidity. The thin portion serves to support the head slider. A reduced rigidity allows the thin portion or head slider to enjoy a responsive change in the attitude.

A specific flexure is provided to realize the aforementioned head suspension assembly. The specific flexure may comprise: a thin portion having a first thickness, the thin portion supporting a head slider; and a thick portion having a second thickness larger than the first thickness. The specific flexure contributes to realization of the aforementioned head suspension assembly.

According to a second aspect of the present invention, there is provided a head gimbal assembly comprising: a head slider; a head suspension; a flexure partly fixed to the head suspension and extending outward from the contour of the head suspension; and a wiring pattern formed on the flexure. The flexure defines at least a thin portion and a thick portion. The thin portion is received on the head suspension for supporting the head slider. The thin portion has a first thickness. The thick portion is formed at a position outside the contour of the head suspension. The thick portion has a second thickness larger than the first thickness. The head gimbal assembly allows the advantages identical to those obtained in the aforementioned head suspension assembly.

The head gimbal assembly may be employed in a specific storage medium drive, for example. The storage medium drive may comprise: a head slider opposed to a storage medium; a head suspension supporting the head slider; a carriage arm supporting the head suspension; a flexure partly fixed to the head suspension and extending outward from the contour of the head suspension, and a wiring pattern formed on the flexure. The flexure defines at least a thin portion and a thick portion. The thin portion is received on the head suspension for supporting the head slider. The thin portion has a first thickness. The thick portion is formed at a position outside the contour of the head suspension. The thick portion has a second thickness larger than the first thickness.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive, HDD, as an example of a storage medium drive according to the present invention;

FIG. 2 is a perspective view schematically illustrating a carriage;

FIG. 3 is a plan view schematically illustrating a head gimbal assembly according to an embodiment of the present invention;

FIG. 4 is a sectional view taken along the line 4-4 in FIG. 3; and

FIG. 5 is a sectional view taken along the line 5-5 in FIG. 3.

### DESCRIPTION OF THE PREFERRED EMBODIMENT

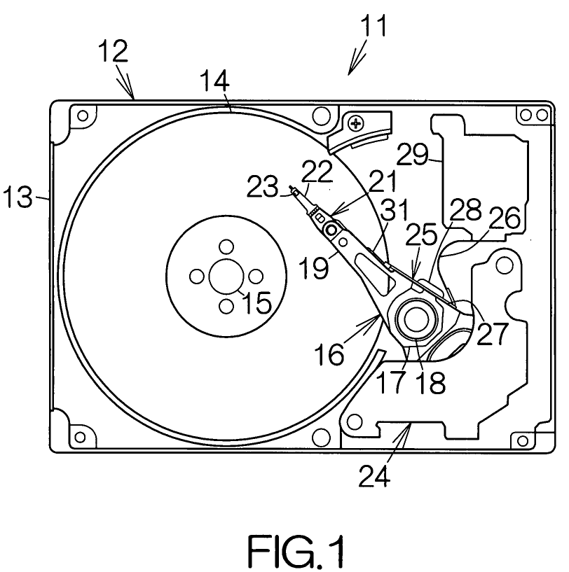

FIG. 1 schematically illustrates the structure of a hard disk drive, HDD, 11 as an example of a storage medium drive or a storage device according to the present invention. The hard disk drive 11 includes an enclosure 12. The enclosure 12 includes a box-shaped base 13 and a cover, not shown. The base 13 defines an inner space in the form of a flat parallelepiped, for example. The base 13 may be made of a metallic material such as aluminum, for example. Molding process may be employed to form the base 13. The cover is coupled to the opening of the base 13. An inner space is defined between the base 13 and the cover. Pressing process may be employed to form the cover out of a plate material, for example.

At least one magnetic recording disk 14 as a storage medium is enclosed in the enclosure 12. The magnetic recording disk or disks 13 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process may be employed to form the carriage block 17, for example.

A head gimbal assembly 21 is attached to the front or tip end of the individual carriage arm 19. A technique of caulking may be employed for the attachment of the head gimbal assembly to the carriage arm 19, for example. The head gimbal assembly 21 has a bore, at the rear end thereof, aligned with a hole defined in the front or tip end of the carriage arm 19 for the employment of caulking technique. The head gimbal assembly 21 includes a head suspension 22 extending forward from the front end of the carriage arm 19. A flying head slider 23 is supported on the front or tip end of the head suspension 22. A head element or electromagnetic transducer is mounted on the flying head slider 23.

When the magnetic recording disk 14 rotates, the flying head slider 23 is allowed to receive an airflow generated along the rotating magnetic recording disk 14. The airflow serves to generate a positive pressure or a lift as well as a negative pressure on the flying head slider 23. The flying head slider 23 is thus allowed to keep flying above the surface of the magnetic recording disk 14 during the rotation of the magnetic recording disk 14 at a higher stability established by the balance between the urging force of the head suspension 22 and the combination of the lift and the negative pressure.

When the carriage 16 swings around the vertical support shaft 18 during the flight of the flying head slider 23, the flying head slider 23 is allowed to move along the radial direction of the magnetic recording disk 14. The electromagnetic transducer on the flying head slider 23 is allowed to cross the data zone defined between the innermost and outermost recording tracks. The electromagnetic transducer on the flying head slider 23 can thus be positioned right above a target recording track on the magnetic recording disk 14.

A power source such as a voice coil motor, VCM, 24 is connected to the carriage block 17. The voice coil motor 24 serves to drive the carriage block 17 around the vertical support shaft 18. The rotation of the carriage block 17 allows the carriage arms 19 and the head gimbal assemblies 21 to swing.

As is apparent from FIG. 1, a flexible printed circuit board unit 25 is located on the carriage block 17. The flexible printed circuit board unit 25 includes a flexible printed wiring board 26. An adhesive may be utilized to attach the flexible printed wiring board 26 to the surface of a metal plate 27 such as a stainless steel plate, for example. A screw or screws may be utilized to fix the metal plate 27 to the carriage block 17, for example.

A head IC (integrated circuit) 28 is mounted on the flexible printed wiring board 26. The head IC 28 is designed to supply the read element of the electromagnetic transducer with a sensing current when the magnetic bit data is to be read. The head IC 28 is also designed to supply the write element of the electromagnetic transducer with a writing current when the magnetic bit data is to be written. A small-sized circuit board 29 is located within the inner space of the enclosure 12. A printed wiring board, not shown, is attached to the outward surface of the bottom plate of the base 13. The small-sized circuit board 29 and the printed wiring board on the bottom plate are designed to supply the head IC 28 with the sensing current and the writing current.

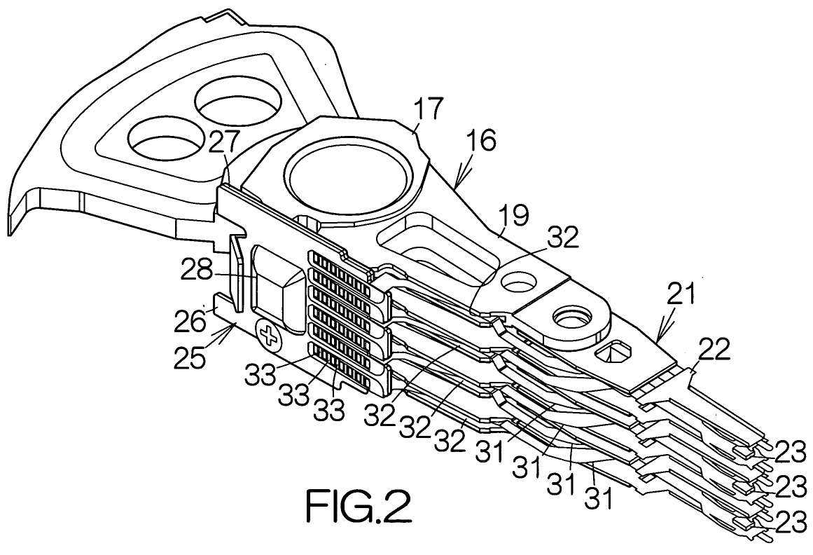

As shown in FIG. 2, a flexure 31 is utilized to relay the sensing current and the writing current to the electromagnetic transducer. One end of the flexure 31 is partly attached to the head suspension 22. The flexure 31 is designed to extend backward from the head suspension 22 along the side of the carriage arm 19. The other end or rear end of the flexure 31 is overlaid on the flexible printed wiring board 26. The flexure 31 has the structure of a so-called long-tail. The flexure 31 may be made of a single plate material such as a stainless steel plate. The carriage arm 19 includes a groove 32 for receiving the flexure 31.

The flying head slider 23 is supported on the front end of the flexure 31, as described later in detail. A flexible printed wiring board, not shown, is formed on the flexure 31. The flexible printed wiring board is designed to extend from the flying head slider 23 to the rear end of the flexure 31. The flexible printed wiring board provides a wiring pattern. One end of the flexible printed wiring board on the flexure 31 is electrically connected to the flying head slider 23. The other end of the flexible printed wiring board is electrically connected to the flexible printed wiring board 26. Electrical connection between the flying head slider 23 and the flexible printed circuit board unit 25 is in this manner established. The flexure 31, the flexible printed wiring board and the head suspension 22 in combination serve as a head suspension assembly according to the present invention.

Six terminals 33, for example, are exposed on the rear end of the individual flexure 31 for establishment of the electrical connection between the flexible printed wiring board on the flexure 31 and the flexible printed wiring board 26. The terminals 33 are defined on the flexible printed wiring board on the flexure 31. The individual terminal 33 is positioned on corresponding one of receiving terminals, not shown, exposed on the surface of the flexible printed wiring board 26. The receiving terminals are connected to a wiring pattern, not shown, on the flexible printed wiring board 26. The wiring pattern is connected to the head IC 28, for example. Solder is utilized to attach the terminals 33 to the corresponding receiving terminals on the flexible printed wiring board 26, for example. Electrical connection is in this manner established between the terminals 33 and the receiving terminals on the flexible printed wiring board 26.

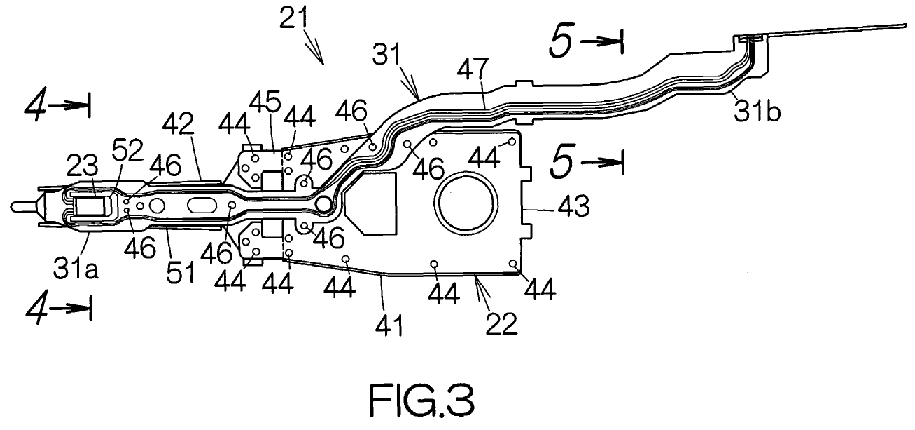

As shown in FIG. 3, the head suspension 22 includes a base plate 41 and a load beam 42. The base plate 41 is attached to the tip end of the carriage arm 19. A load beam 42 is distanced forward from the base plate 41 at a predetermined interval. Caulking process is employed to attach the base plate 41 to the carriage arm 19, for example. A hinge plate 43 is fixed to the surfaces of the base plate 41 and the load beam 42. Spot welding may be effected at joint spots 44 so as to fix the hinge plate 43 to the base plate 41 and the load beam 42, for example. A YAG laser is utilized in the spot welding, for example. The hinge plate 43 provides an elastic bending section 45 between the front end of the base plate 41 and the rear end of the load beam 42. The hinge plate 43 serves to couple the base plate 41 with the load beam 42.

The flexure 31 is partly fixed to the surface of the head suspension 22. Spot welding may be effected at joint spots 46 so as to fix the flexure 31 to the head suspension 22, for example. A YAG laser is utilized in the spot welding, for example. A flexible printed wiring board 47 is formed on the surface of the flexure 31. The flexible printed wiring board 47 provides a wiring pattern as described above. The flexible printed wiring board 47 extends from the front end of the flexure 31 to the rear end of the flexure 31. The printed wiring board 47 may include an insulating layer, an electrically-conductive layer and a protection layer, overlaid on the flexure 31 in this sequence, for example. The electrically-conductive layer may be made of an electrically-conductive material such as copper. The insulating layer and the protection layer may be made of a resin material such as polyimide resin.

The flexure 31 includes a thin portion 31a and a thick portion 31b. The thin portion 31a is partly fixed to the surface of the head suspension 22, namely the surfaces of the load beam 42 and the hinge plate 43. The thick portion 31b is located at a position outside the contour of the head suspension 22. The thin portion 31a defines a fixation plate 51 and a support plate 52. The fixation plate 51 is fixed to the surfaces of the load beam 42 and the hinge plate 43. The support plate 52 receives the flying head slider 23 at the surface of the support plate 52. An adhesive may be employed to bond the flying head slider 23 to the surface of the support plate 52.

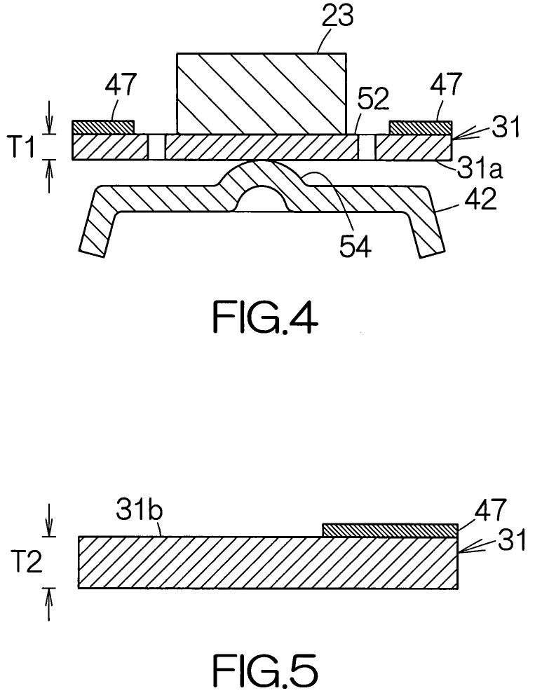

As shown in FIG. 4, the thickness of the thin portion 31a is set at a first thickness T1. The flying head slider 23, namely the back surface of the support plate 52 is received on a domed protrusion 54 formed on the surface of the load beam 42. The aforementioned elastic bending section 45 generates a predetermined elastic force or bending force. The bending force serves to urge the front end of the load beam 42 toward the surface of the magnetic recording disk 14. The urging force is transmitted to the head slider 23 from the back of the support plate 52 through the protrusion 54. The flying head slider 23 is allowed to change its attitude based on the distribution of the lift depending on the airflow. The protrusion 54 enables the change in the attitude of the flying head slider 23 or the support plate 52.

As shown in FIG. 5, the thickness of the thick portion 31b is set at a second thickness T2 larger than the first thickness T1. The thick portion 31b is located at a position outside the contour of the head suspension 22 in the flexure 31. Since the thick portion 31b has the second thickness T2 larger than the first thickness T1 of the thin portion 31a, the thick portion 31b exhibits a sufficient rigidity. The terminals 33 on the flexure 31 can thus be positioned on the receiving terminals on the flexible printed wiring board 26 in a facilitated manner during the assembling of the carriage 16. The terminals 33 can thus be bonded to the receiving terminals on the flexible printed wiring board 26 without any difficulty.

Since the thin portion 31a has the first thickness T1 smaller than the second thickness T2 of the thick portion 31b, the thin portion 31b exhibits a reduced rigidity. The thin portion 31a or the support plate 52 changes its attitude on the protrusion 54 as described above. A reduced rigidity of the support plate 52 allows the flying head slider 23 to enjoy a change in the attitude responsive to a change of the airflow. The flying head slider 23 is thus allowed to enjoy an improved flying characteristic. It should be noted that the thin portion 31a may be defined at least in front of the front joint spot or spots 46 closest to the front end of the flexure 31. In this case, the thick portion 31b may be defined behind the mentioned front joint spot or spots 46 closest to the front end of the flexure 31.

Pressing process may be employed to make the flexure 31, for example. A stainless steel plate is set on a pressing machine. The stainless steel plate has a size enough to define the flexure 31, for example. The thickness of the stainless steel plate may be set at the second thickness T2, for example. The stainless steel plate is allowed to receive a pressure over a predetermined area. The flexure 31 is simultaneously punched out of the stainless steel plate. Alternatively, etching process may be employed to prune the flexure 31 out of the stainless steel plate by melting the stainless steel plate outside the contour of the flexure 31, for example.

Otherwise, etching process may be employed to make the flexure 31, for example. A mask is formed over a predetermined section on a stainless steel plate, for example. The predetermined section corresponds to the shape of the thick portion 31b. Etchant is subsequently applied to the stainless steel plate. Etchant serves to melt the stainless steel plate outside the mask. This results in formation of the thin portion 31a outside the mask. The thick portion 31b is defined within the section under the mask. The flexure 31 may then be punched out of the stainless steel plate in the same manner as described above.

What is claimed is:

1. A head suspension assembly comprising:
a head suspension;
a flexure partly fixed to the head suspension and extending outward from a contour of the head suspension, said flexure made of a plate material; and
a wiring pattern formed on the flexure, wherein
the flexure defines at least a thin portion and a thick portion, said thin portion received on the head suspension for supporting a head slider, said thin portion having a first thickness, said thick portion formed at a position outside the contour of the head suspension, said thick portion having a second thickness larger than the first thickness.

2. A flexure comprising:
a thin portion having a first thickness, said thin portion supporting a head slider; and
a thick portion having a second thickness larger than the first thickness.

3. A head gimbal assembly comprising:
a head slider;
a head suspension;
a flexure partly fixed to the head suspension and extending outward from a contour of the head suspension, said flexure made of a plate material; and
a wiring pattern formed on the flexure, wherein
the flexure defines at least a thin portion and a thick portion, said thin portion received on the head suspension for supporting the head slider, said thin portion having a first thickness, said thick portion formed at a position outside the contour of the head suspension, said thick portion having a second thickness larger than the first thickness.

4. A storage medium drive comprising:
a head slider opposed to a storage medium;
a head suspension supporting the head slider;
a carriage arm supporting the head suspension;
a flexure partly fixed to the head suspension and extending outward from a contour of the head suspension, and
a wiring pattern formed on the flexure, wherein
the flexure defines at least a thin portion and a thick portion, said thin portion received on the head suspension for supporting the head slider, said thin portion having a first thickness, said thick portion formed at a position outside the contour of the head suspension, said thick portion having a second thickness larger than the first thickness.
